(19) United States
(12) Patent Application Publication
(10) Pub. No.: US 2013/0192926 A1
(43) Pub. Date: Aug. 1, 2013

(54) Extension ladder

(71) Applicant: Gene R. Schmidt, Lafayette, CA (US)

(72) Inventor: Gene R. Schmidt, Lafayette, CA (US)

(21) Appl. No.: 13/506,647

(22) Filed: May 7, 2012

Related U.S. Application Data
(60) Provisional application No. 61/632,560, filed on Jan. 26, 2012.

(51) Int. Cl. E06C 1/12; E06C 7/04

(52) U.S. Cl. 182/208; 182/209

(57) ABSTRACT

An extension ladder is disclosed. The extension ladder includes a bottom stage and a top stage that are interlocked and configured to telescope with respect to each other, such that the top stage extends from a back surface of the bottom stage to an extended position. In the extended position the bottom stage and top stage are locked and secured together through one or more securing features such that overlapping rungs from the bottom stage and the top stage are substantially aligned and parallel to provide a stable stepping plane with the extension ladder leaning to form an acute angle between the back surface of the bottom stage and a support surface.

### RELATED APPLICATION

This application claims priority under 35 U.S.C. §119(e) from the co-pending U.S. provisional patent application Ser. No. 61/632,560, filed on Jan. 26, 2012, and titled “EXTENSION LADDER.” The provisional patent application Ser. No. 61/632,560, filed on Jan. 26, 2012, and titled “EXTENSION LADDER” is hereby incorporated by reference.

### FIELD OF THE INVENTION

This invention relates generally to construction equipment. More specifically, this invention relates to extension ladders.

### BACKGROUND

There are a number of different ladders that are used in the field of construction. There are collapsible painter's ladders, collapsible wall ladders and extension ladders to names a few. A extension ladder, herein refers to a ladder that includes two of more stages that telescope in an extended fashion with respect to each other and lock into the extended position.

### SUMMARY OF THE INVENTION

The present invention is directed to an extension ladder. The extension ladder includes a bottom stage and a top stage that are interlocked and configured to telescope with respect to each other. The top stage and the bottom stage are formed from elongated side supports and elongated rungs that are substantially perpendicular to the elongated sides supports and substantially parallel with a support surface with the extension ladder in an upright position. The top stage is configured to extend or telescope to an extended position from a back portion of the bottom stage with the extension ladder in the upright position. With the extension ladder in the extended position and leaning at an acute angle formed between the back portion of the bottom stage a support surface, overlapping rungs from the bottom stage and the top stage are substantially aligned and parallel to provides a stable stepping plane.

The extension ladder of the present invention includes a securing or locking mechanism that secures the bottom stage and the top stage in the extended position and with overlapping portion of the rungs from the bottom stage and the top stage aligned, such as described above. The securing or locking mechanism includes, for example, one or more latch features that are attached to either the bottom stage or the top stage of the extension ladder and are configured to hook around and secure to a rung or rungs on the other of the bottom stage or the top stage of the extension ladder. Preferably, the one or more latch features are fixed to one or more interior surfaces of the elongated side supports of the bottom stage or the top stage.

The rungs of the bottom stage and/or the top stage are angle rungs, round rungs or any combination thereof. The extension ladder in accordance with further embodiments of the invention includes a mechanism for extending the top stage relative to the bottom stage. For example the extension ladder includes a push handle attached to the top stage of the extension ladder, a pulley feature attached to the bottom stage of the extension ladder or a combination thereof. Preferably, the bottom stage of the extension ladder includes support platforms for stabilizing the extension ladder in the extend position with the extension ladder leaning against a structure at an acute angle that is formed by the back surface of the bottom stage of the step ladder and a support surface.

### BRIEF DESCRIPTION OF THE FIGURES

FIG. 1 shows a prior art extension ladder.

FIG. 2 shows an extension ladder, in accordance with the embodiments of the invention.

FIG. 3A-D are schematic diagrams showing positioning of ladder rungs on prior art extension ladders.

FIG. 4 illustrates securing or latch features used in the extension ladders.

FIG. 5 shows an extension ladder with a pulley feature, in accordance with the embodiments of the invention.

### DETAILED DESCRIPTION OF THE INVENTION

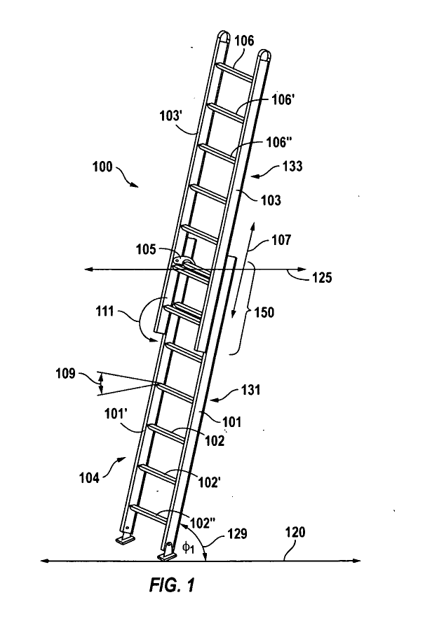

Referring to FIG. 1, a prior art extension ladder 100 includes a bottom stage 101 and a top stage 103. The stages 101 and 103 are configured to telescope or extend with respect to each other in a direction indicated by the arrow 107. The top stage 103 is configured to extend from a front portion 104 of bottom stage 101 through guide or track features (not shown). The bottom stage 101 and the top stage 103 are locked into an extended position through one or more securing or latch features 105. Each of the bottom stage 101 and top stage 103 have a number of rungs or steps 102, 102′ and 102″ and 106, 106′ and 106″, respectively. In some cases, the rungs 102, 102′, 102″, 106, 106′ and 106″ are angled, as indicate by the arrow 109, such that flattened portions of the rungs steps are substantially parallel to the ground or support surface 120 with the extension ladder 100 leaning and forming an acute angle 129 with the support surface 120 and with the top stage 103 extended from the front portion 104 of the bottom stage 101, a shown.

Alternatively, the rungs 102, 102′ and 102″ and 106, 106′ and 106″ are rounded. Regardless of whether the rungs 102, 102′ and 102″ and 106, 106′ and 106″ are angled or rounded, the securing or latch features 105 are configured to secure the extension ladder in the extended position such that overlapping portions 150 of the rungs 102, 102′ and 102″ and 106, 106′ and 106″ are aligned and substantially parallel with the support surface 120 to provide a flat or stable stepping surface, as indicated by the arrow 125.

When a person goes up the extension ladder 100 from the bottom stage 101 via the rungs 102, 102′ and 102″ the person has to step outward to hit or land on a rung of the overlapping portion 150 of the top stage 103, which can be difficult when the extension ladder 100 in a substantially vertical or the acute angle 129 is large. More problematic, when the person goes down the extension ladder 100 via the rungs 106, 106′ and 106″, the person has to step inward, as indicate by the arrow 111, to hit or land on the rungs of the bottom stage 101. Often the person can not see the first accessible rung of the bottom stage 101 and since stepping inward is difficult, the person can loose his or her balance and fall while acceding from the extension ladder 100.

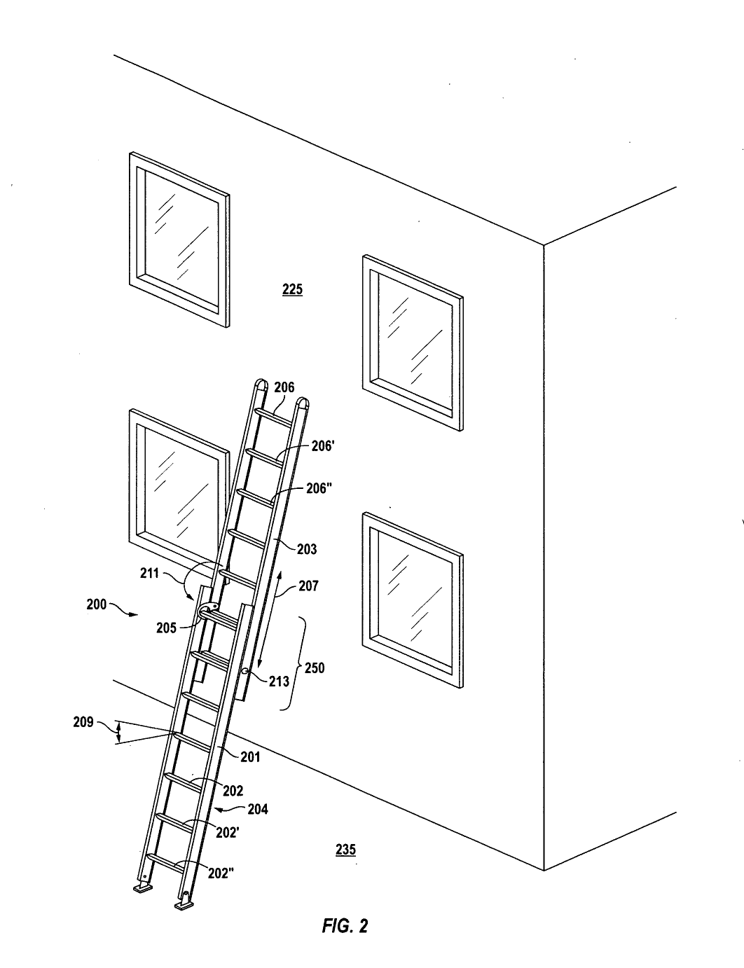

Referring to FIG. 2, the extension ladder 200 of the present invention includes a plurality of stages, such as a bottom stage 201 and a top stage 203. The stages 201 and 203 are configured to telescope or extend with respect to each other in the direction indicated by the arrow 207. The bottom stage and the top stage are formed from side supports and each have a number or rungs 202, 202′ 202″ and 206, 206′ and 206″ that are angled, as indicate by the arrow 209, or rounded, such as described above.

In accordance with the embodiments of the invention, the top stage 203 is configured to extend from a back portion 204 of lower stage 201 through guide or track features (not shown). The bottom stage 201 and the top stage 203 are locked into an extended position through one or more securing or latch features 205. The one or more securing or latch features 205 are configured to secure the extension ladder in the extended position such that overlapping portions 250 of the rungs 202, 202′ 202″, 206, 206′ and 206″ are aligned and substantially parallel with the support surface 235 to provide a flat or stable stepping surface.

In operation, the extension ladder 200 of the present invention is placed in the extended position as shown and is leaned up against a structure 225. When a person goes up the extension ladder 200 from the bottom stage 201 via the rungs 202, 202′ and 202″ on the bottom stage, the person has to step inward or forward to hit or land on a rungs 206, 206′ and 206″ of the top stage. Stepping inward or forward is easy to execute when the extension ladder 200 in leaning at an acute angle formed by the back portion 204 of the bottom stage 203 and the support surface 235. Further, when the person goes down the extension ladder 200 via the rungs 206, 206′ and 206″ of the top stage 203, the person has to step outward or backward, as indicate by the arrow 211, to hit or land on a step on an overlapping rung the bottom stage 201. Stepping outward or backward while ascending the extension ladder 200 is again a natural motion and is easy to execute. In accordance with the embodiments of the invention, the extension ladder 200 further includes a handle or push mechanism 213 to assist placing the extension ladder 200 in the extended position, as shown in FIG. 2.

The extension ladder 200 configuration of the present invention is not achieved by turning the prior art extension ladder 100 around 180 degree or by placing the top stage 103 on a back surface of the first stage 101 for a number of reasons explained below.

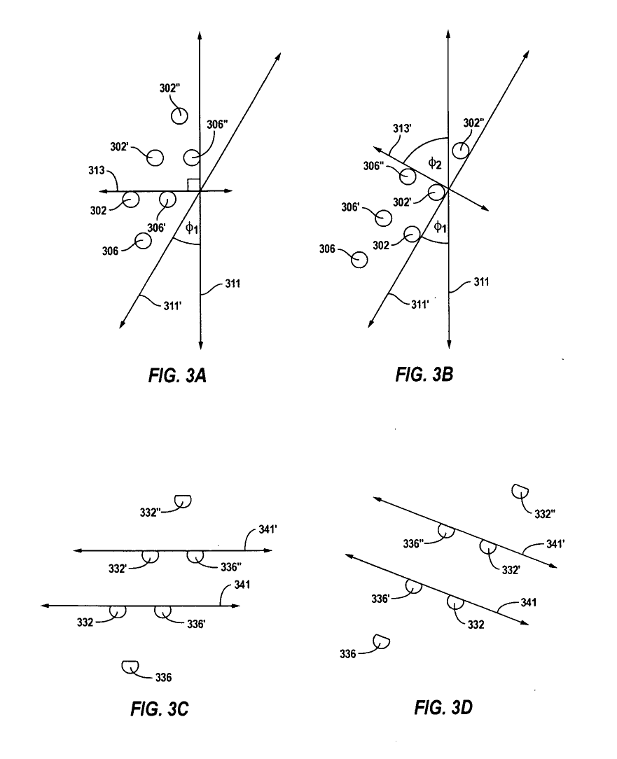

FIG. 3A shows a schematic representation of an overlapping section of rungs 302, 302′ and 302″ from and upper stage and rungs 306, 306′ and 306″ from a lower stage. The prior art extension ladder shown in FIG. 1 is constructed such that the rungs 302, 302′ and 302″ from the upper stage and the rungs 306, 306′ and 306″ from the lower stage are aligned and overlapping with the step ladder in an extended position and leaning at an acute angle indicted by the arrows 311 and 311″. This provides a flat or stable stepping surface, as indicated by the arrow 125, that is approximately at a right angle with the arrow 311. Flipping the extension ladder around 180 degree results in a configuration or rungs schematically represent in FIG. 3B.

As illustrated in FIG. 3B, the rungs 302, 302′ and 302″ from and upper stage and rungs 306, 306′ and 306″ from a lower stage are no longer aligned with the extension ladder leaning at an acute angle indicted by the arrows 311 and 311″. The overlapping rungs are now angled, such that the stepping surface 313′ is at an acute angle with respect the arrow 311. Accordingly, the step ladder of the present invention require that the securing mechanism is relocated to a different position on one or more of the side supports 101, 101′ 103 and 103′ of the bottom stage and/or the top stage to achieve the preferred alignment of overlapping rungs 302, 302′ and 302″ from and upper stage and overlapping rungs 306, 306′ and 306″ from a lower stage.

FIGS. 3C shows a schematic representation of an overlapping section of rungs 332, 332′ and 332″ from and upper stage and rungs 336, 336′ and 336″ from a lower stage of a prior art extension ladder. In this case, the rungs 332, 332′ and 332″ from and upper stage and the rungs 336, 336′ and 336″ are tampered. Note that in FIG. 3C, the rungs 302, 302′ and 302″ from the upper stage and the rungs 306, 306′ and 306″ from the lower stage are aligned and overlapping while leaning at an acute angle to provide a flat or stable stepping surface between overlapping rungs, as indicated by the arrows 341 and 341″ For all of the reasons described above, flipping the extension ladder around 180 degree results in a misalignment o overlapping portions of the rungs 332, 332′ and 332″ from and upper stage and rungs 336, 336′ and 336″ from a lower stage, as shown in FIG. 3D. Further, in the case where the rungs 332, 332′ and 332″ from and upper stage and the rungs 336, 336′ and 336″ from a lower stage are flattened or tampered, the flattened or tampered portions are now angled inward as indicated by the arrow 341 and 341″. Therefore, regardless of whether the rungs on the extension ladder are rounded or tampered, the extension ladder of the present invention requires that a securing mechanism that is re-positioned and/or modified to achieve alignment and proper positioning of overlapping portions of rungs from the upper stage and bottom stage.

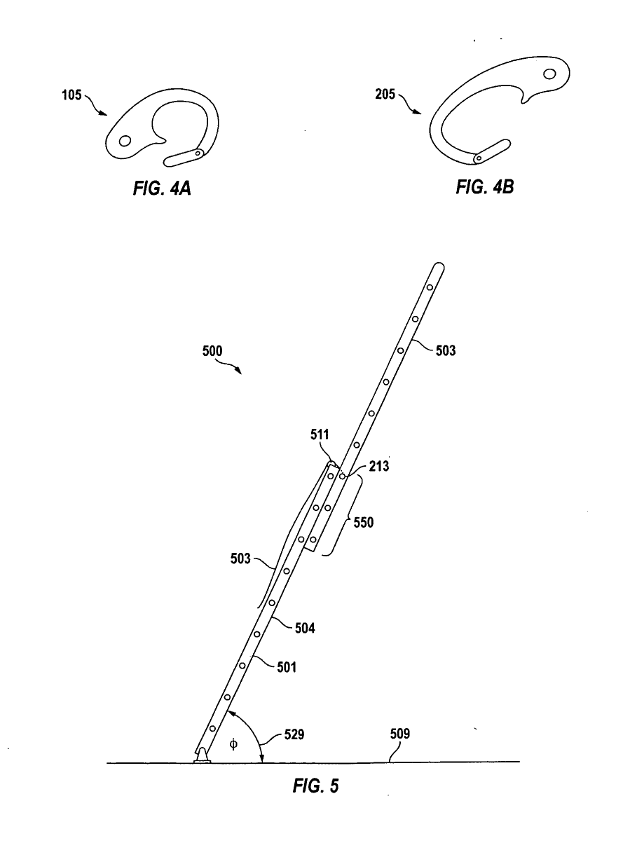

FIG. 4A shows a latch mechanism 105 that is typically used in an extension ladder. One or more of the latch mechanisms 105 are typically attached to side supports of an upper stage. When the upper stage is extended from the front surface of a lower stage, the one or more latch mechanisms secure around one or more of the rungs on the bottom stage to secure the extension ladder in the extended position. The extension ladder of the present invention have modified latch features that are positioned in a different locations than those that are used in prior art extension ladders. The latch features used in the extension ladder of the present invention, the mounting surfaces and attachment hardware is preferably modified and in some cases the latch mechanisms 205 are elongated and/or otherwise built as shown in FIG. 4B.

Referring now to FIG. 5, the extension ladder 500 of the present invention has a bottom stage 501 and a top stage 503. The top stage 503 is configured to extend or telescope from a back surface 504 of the bottom stage 501, such as described above. The step ladder is secured in an extended position, such s shown, through one or more securing mechanism. In the extended position the overlapping portions 550 of rungs on the bottom stage 501 and the top stage 503 are aligned to provide a substantially flat or stable stepping surface with the extension ladder 500 leaning at an acute angle 529 formed by the back surface 504 of the lower stage 501 and a support surface 509. As described above, the extension ladder 500 in accordance with the embodiments of the invention includes a handle or push mechanism 213 to assist placing the extension ladder 500 in the extended position. In addition to the handle or push mechanism 213, or instead of the handle or push mechanisms 213, the extension ladder 500 is also equipped with a pulley 511 and rope 503 to facilitate extending the top stage 503 relative to the bottom stage 501.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention. For example, while the extension ladder has been shown to have two stages, a bottom stage and a top stage, any number or stages are contemplated to be within the scope of the invention.

What is claimed is:

1. An extension ladder comprising;
a) a bottom stage and a top stage that are interlocked and configured to telescope with respect to each other, each of the bottom stage and the top stage having elongated side supports and elongated rungs that are substantially perpendicular to the elongated sides supports; and
b) one or more latch features fixed to one of the top stage or bottom stage and configured to hook around and secure to at least one rung on the other of the bottom stage and the top stage, such that a portions of the rungs from both of the bottom stage and top stage are aligned and substantially parallel to each other with the ladder in an extended position and leaning against a structure at an angle with the top stage interior to the bottom stage and touching the structure and the bottom stage exterior to the top stage.

2. The extension ladder of claim 1, where in the elongated rungs are angled.

3. The extension ladder of claim 1, further comprising a mechanism for extending the top stage relative to the bottom stage.

4. The extension ladder of claim 3, wherein the mechanism for extending the top stage relative to the bottom stage comprises a handle feature.

5. The extension ladder of claim 3, wherein the mechanism for extending the top stage relative to the bottom stage comprises a pulley feature.

6. The extension ladder of claim 1, wherein the bottom stage includes support platforms for stabilizing the extension ladder on a surface while the extension ladder is leaning against the structure at the angle.

7. An extension ladder comprising:
a) a bottom stage with angled rungs; and
b) a top stage with angled rungs, wherein the top stage extends from a back portion of the bottom stage and the top stage includes one or more latch features that hook around and secure to at least one of the angled steps on the bottom stage, such that the portions the angle rungs from both of the bottom stage and top stage are aligned and substantially parallel with the ladder in and extended position and leaning against a structure at an angle with the top stage interior between the bottom stage and the structure.

8. The extension ladder of claim 7, further comprising a mechanism for extending the top stage relative to the bottom stage.

9. The extension ladder of claim 8, wherein the mechanism for extending the top stage relative to the bottom stage comprises a handle feature.

10. The extension ladder of claim 8, wherein the mechanism for extending the top stage relative to the bottom stage comprises a pulley feature.

11. The extension ladder of claim 7, wherein the bottom stage includes support platforms for stabilizing the extension ladder on a surface while the extension ladder is leaning against the structure at the angle an in the extended position.

12. An extension ladder comprising:
a) a bottom stage with rungs;
b) a top stage with rungs, wherein the top stage extends from a back portion of the bottom stage to an extended position; and
c) a locking mechanism that secures the bottom stage and top stage with portions of the rungs from the bottom stage and portions of the rungs from the top stage aligned and substantially parallel with the ladder in the extended position and leaning at an acute angle formed between the back portion of the bottom stage a support surface.

13. The extension ladder of claim 12, wherein a portion of the rungs from the bottom stage and the top stage are angled.

14. The extension ladder of claim 12, further comprising a mechanism for extending the top stage relative to the bottom stage.

15. The extension ladder of claim 14, wherein the mechanism for extending the top stage relative to the bottom stage comprises a handle feature.

16. The extension ladder of claim 14, wherein the mechanism for extending the top stage relative to the bottom stage comprises a pulley feature.

17. The extension ladder of claim 12, wherein the bottom stage includes support platforms for stabilizing the extension ladder on a surface while the extension ladder is leaning against a structure at the acute angle.

18. The extension ladder of claim 12, wherein the locking mechanism includes one or more latches.

19. The extension ladder of claim 13, wherein the one or more latches are attached and fixed to the top stage.
